(19) United States
(12) Patent Application Publication
(10) Pub. No.: US 2025/0061424 A1
(43) Pub. Date: Feb. 20, 2025

(54) EMPLOYEE STAFFING METHOD

(71) Applicants: Meenakshi Thakur, Delta (CA); Harinder Singh Kanwar, Brampton (CA); Monika Kesar, Brampton (CA)

(72) Inventors: Meenakshi Thakur, Delta (CA); Harinder Singh Kanwar, Brampton (CA); Monika Kesar, Brampton (CA)

(21) Appl. No.: 18/449,965

(22) Filed: Aug. 15, 2023

(51) Int. Cl. G06Q 10/1053

(52) U.S. Cl. CPC G06Q 10/1053

(57) ABSTRACT

An employee staffing method that is operable to provide employers with labor candidates wherein the present invention facilitates filling of available positions wherein the positions can include but are not limited to immediate shift work for the same day. The present invention provides a platform facilitated by a software application that automates the ability for job candidates and employers to communicate about instant job opportunities. The employee staffing method of the present invention further provides payment to the candidates upon completion of a job shift or task wherein the employer subsequently reimburses the operator of the employee staffing method. The present invention includes process steps for candidates that include resume creation and alerts to job postings that meet the criteria sought by the job candidate. The present invention is provided in multiple languages and a management dashboard for employers.

### FIELD OF THE INVENTION

The present invention relates generally to employment staffing, more specifically but not by way of limitation, a method for employers to identify and retain temporary labor, specifically labor that is required by the employer the day of identification and engagement of the potential labor.

### BACKGROUND

Millions of individuals regularly look for jobs and employers are consistently seeking new workers to either add to their existing workforce or replace lost members of their workforce. This general process has occurred for decades and various tools and resources have been utilized to accomplish the matching of a job seeker with an employment opportunity. Traditional methods of publishing job opportunities are still utilized and has migrated from conventional print ads to electronic techniques such as but not limited to social media posts and other websites that provide listings of various job opportunities for different industries. Another resource that is commonly utilized is a recruiting agency. Recruiting agencies will utilize recruiters that first work with employers to understand the needs and requirements of the open job opportunities. Subsequently, the recruiter will leverage their network and other techniques to identify potential candidates, screen the candidates and present to the employer for review.

While the existing processes have been effective at matching job seekers with potential employers, the process is overall very cumbersome, time consuming and not suited for some categories of labor requirement that need to be fulfilled for an employer. An example of this is temporary labor, in particular, temporary labor requirements that need to be filled on the same day or within a short time period such as but not limited to twenty four hours. Many employers often find themselves short on required labor on any given day that can be caused by unusual demand, staffing shortage or other reasons. While the aforementioned recruiting agencies can help place employees for short term engagements, their processes are not capable of finding and placing labor on the same day. Additionally, there is a portion of the labor pool that prefers to seek temporary work in location for which they may only be present for a short amount of time or prefer to work on their own schedule on days that accommodate their personal needs.

Accordingly, there is a need for a method that is operable to assist employers find individuals that can fulfill labor needs wherein the labor needs are required by the employer on the same day and wherein the individual is seeking work and compensation on the same day.

### SUMMARY OF THE INVENTION

It is the object of the present invention to provide a method facilitated by a software application that is configured to assist employers find individuals to work for the employer on a day of identification wherein the present invention includes a step of registering a multitude of individuals available to work on short notice.

Another object of the present invention is to provide a method of finding and employing labor on the same day wherein the registered multitude of individuals are categorized in the software application by skillset and capabilities.

A further object of the present invention is to provide a method facilitated by a software application that is configured to assist employers find individuals to work for the employer on a day of identification wherein the employer electronically communicates wherein the software application of the present invention facilitates an ability for a job seeker to have their labor availability bid upon by potential employers.

Yet a further object of the present invention is to provide a method of finding and employing labor on the same day wherein the software application of the present invention identifies a labor pool of job seekers in the geographic vicinity of the employer.

Still another object of the present invention is to provide a method facilitated by a software application that is configured to assist employers find individuals to work for the employer on a day of identification wherein the software application of the present invention facilitates the financial transaction for services rendered on the same day the job seeker performed the required labor for the employer.

An additional object of the present invention is to provide a method of finding and employing labor on the same day wherein the software application of the present invention provides geolocation tracking of the temporary employee.

Yet a further object of the present invention is to provide a method facilitated by a software application that is configured to assist employers find individuals to work for the employer on a day of identification wherein the software application of the present invention provides timekeeping for the labor performed for the employer.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exemplary process flow for the employer utilizing the present invention; and

FIG. 2 is an exemplary process flow for the job seeker utilizing the present invention; and

FIG. 3 is an exemplary process flow for an operator of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated an employee staffing method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the employee staffing method 100 has the exemplary workflow diagrammed therein for an exemplary interaction with the software application of the present invention from the perspective of the job seeker, employer and operator of the present invention. Prior to discussion of the aforementioned a general description of features of the present invention is as follows. For job seekers (candidates) the software application of the present invention includes a resume builder tool that allows job seekers to create and edit their resumes. Job search functionality that allows job seekers to search for relevant job openings based on location, industry, and keywords. Furthermore, the present invention provides the ability for a job seeker to filter and sort options search results based on job type, salary and distance. The present invention further provides an application tracking system that enables job seekers to view the status of their job applications. The employee staffing method 100 further provides chat communication functionality that allows job seekers to communicate with employers and recruiters to ask questions or clarify any information related to the job opening.

For employers and recruiters utilizing the employee staffing method 100 some of the general features are as follows. The employee staffing method 100 provides job posting and management tools that allow employers to post job openings, manage applications, and communicate with candidates through the app. The present invention provides candidate screening tools enabling recruiters and employers the ability to screen and filter job applications based on specific criteria, such as education, experience, and skills. Another feature of the employee staffing method 100 is an interview scheduling functionality that allows recruiters to schedule interviews with candidates through the app. An applicant tracking system that provides an overview of all applications received and their status in the recruitment process. The employee staffing method 100 provides a graphical interface dashboard with analytics and insights to track job postings' performance, view applicant demographics, and monitor other recruitment metrics. The software application of the present invention provides integration with social media platforms for information distribution about job openings and attraction more applicants.

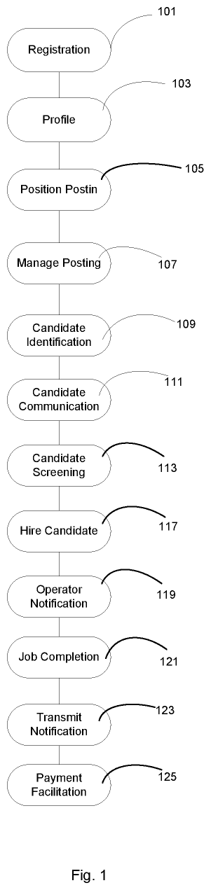

Now referring in particular to FIG. 1 submitted herewith, an exemplary process for an employer utilizing the present invention is diagrammed therein. In step 101, an employer will register with the employee staffing method 100 utilizing the software application thereof. Step 103, the employer will create a profile within the software application. It should be understood within the scope of the present invention that profile creation will include data parameters such as but not limited to banking information, business location and business demographics. In step 105, ensuing creation of the profile, the employer will utilize the software application of the present invention to post at least one available job position. It should be understood within the scope of the present invention that the employee staffing method 100 has a primary focus on filling available job openings wherein the job openings are for a single work shift and for which it is desired to find labor on the same day or within a short time period such as but not limited to twenty-four hours. While this is a feature of the employee staffing method 100 it should still be understood that the employee staffing method 100 could be utilized to find candidates for job openings along a traditional timeline.

Step 107, the employer will manage the job posting availability and other parameters related thereto. In step 109, the employer will receive identification of a candidate for the posted job opening. Candidate submission is discussed in more detail herein. Step 111, the employer and candidate will utilize the communication feature of the present invention to exchange communications therebetween about details of the job position and candidate qualifications. In step 113, ensuing initial communication, the employer will conduct any further candidate screening that may be required. Step 117, the employer will hire the candidate. As discussed herein, the hiring of the candidate can be permanent of temporary. In step 119, upon hiring of the candidate, the software application of the present invention will transmit a notification to the operator of the employee staffing method 100. Step 121, the candidate will complete the job for the employer. It should be understood that the exemplary process flow discussed is for temporary labor needs for the employer. Step 123, upon completion of the job, the employer will transmit a notification via the software of the present invention to the operator that the job has been completed. Step 125, the operator will utilize the software application of the present invention to send electronic payment for the job completion to the candidate within an hour of receiving completion notification. The operator will be subsequently reimbursed by the employer wherein a processing fee is additionally paid to the operator.

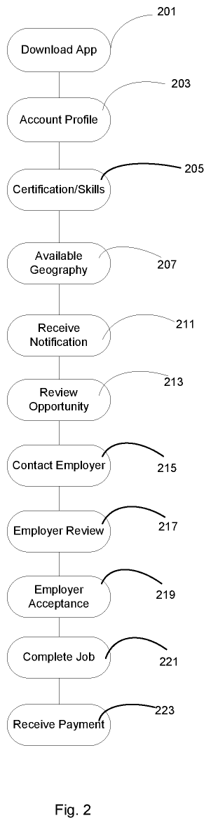

Referring in particular to FIG. 2 submitted herewith, an exemplary process for a candidate is outlined therein. In step 201, the candidate will download the software application of the present invention to a suitable computing device such as but not limited to a smartphone. Step 203, the candidate will create an account profile within the software application of the present invention. The account profile will include data parameters such as but not limited to legal identification, bank account data and geographic availability for work. In step 205, the candidate will load into the software application any certifications and will complete a skillset profile as well as upload a resume. Step 207, the candidate will enter their geographic availability for work utilizing postal zip codes and subsequently activate their profile so as to be available for any position postings.

In step 211, the candidate will receive a notification of a job opening that matches the candidates' criteria and capabilities. It should be understood within the scope of the present invention that the job opening could be for a temporary or permanent position. Step 213, the candidate will review the job opportunity in the software application of the present invention. In step 215, the candidate will contact the employer through the communication feature integral into the software application of the present invention. Step 217, the employer will review the credentials and availability of the job candidate. Step 219, the employer will accept the candidate and extend an offer thereto. In step 221, the candidate will complete the job task and submit notification of the completion to the operator of the employee staffing method 100 via the software application of the present invention. Step 223, the candidate will receive payment for completion of the job electronically within an hour of completion of the job. It should be further understood within the scope of the present invention that the operator could verify job completion with the employer prior to facilitating payment for job completion.

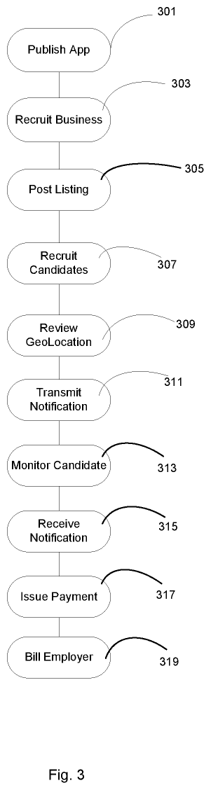

Now referring in particular to FIG. 3 submitted herewith, an exemplary process flow for an operator of the employee staffing method 100 is outlined therein. In step 301, the operator will publish the software application of the present invention to a suitable location for downloading thereof by employers and candidates. Step 303, the operator will recruit business to register with the employee staffing method 100. In step 305, ensuing registration a business will submit job postings to list which will be reviewed by the operator and posted in the software application of the present invention. Step 307, the operator of the employee staffing method 100 will additionally advertise to candidates so as to drive awareness of the employee staffing method 100. In step 309, the operator of the employee staffing method 100 will consistently review the geographic locations of the businesses and candidates to ensure alignment thereof. Step 311, subsequent to receiving the job postings, the operator will employ the software application of the present invention to transmit notifications thereabout to the candidates registered with the employee staffing method 100 that fulfill the job requirements and required geographic location. In step 313, the operator of the employee staffing method 100 monitors the activity of the candidate and their interactions with employers in the software application. Step 315, the operator receives notification of job completion ensuing candidates completing a job. In step 317, the operator will issue payment to the candidate for a job completed subsequent receiving notification of the job completion. Step 319, ensuing payment to the candidate, the operator of the employee staffing method 100 will issue an invoice for payment to the employer which will include a processing fee in addition to the amount paid to the candidate.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An employee staffing method facilitated by a software application that is operable to assist employers find candidates to fill job positions wherein the employee staffing method comprises the steps of:
publishing the software application, wherein the software application is published to a location accessible for downloading thereof onto a multitude of computing devices;
registering a multitude of businesses, wherein the multitude of businesses create account profiles for display in the software application;
registering a multitude of job candidates, wherein the multitude of job candidates create account profiles for use within the software application;
posting an available position in the software application, wherein at least one business of the multitude of businesses posts information about a job opening, reviewing the job opening post, wherein an operator of the employee staffing method reviews the job opening post;
transmitting a notification to the multitude of job candidates, wherein the software application transmits an alert to job candidates having a skillset and credentials that align with requirements of the job opening;
reviewing the notification, wherein at least one of the multitude of job candidates reviews the alert regarding the job opening;
contacting the employer, wherein the at least one of the multitude of job candidate contacts the employer to accept the job opening;
reviewing the job candidate, wherein the employer reviews the job candidate inquiring about the job opening;
agreeing to accept the job opening, wherein the at least one of the multitude of job candidates agrees with the employer to accept the job;
performing work required for the job opening, wherein the job candidate executes required tasks of the job opening; and
paying the job candidate, wherein the job candidate is paid electronically through the software application upon completion of the job opening.

2. The employee staffing method facilitated by a software application that is operable to assist employers find candidates to fill job positions as recited in claim 1, wherein the operator of the employee staffing method pays the job candidate within an hour of completion of tasks required for the job opening.

3. The employee staffing method facilitated by a software application that is operable to assist employers find candidates to fill job positions as recited in claim 2, and further including a step of transmitting an invoice to the employer, wherein the operator transmits and invoice for reimbursement of money paid to the job candidate.

4. The employee staffing method facilitated by a software application that is operable to assist employers find candidates to fill job positions as recited in claim 3, and further including a step of verifying geographic availability, wherein the geographic availability for the multitude of job candidates is reviewed and recorded within the software application.

5. The employee staffing method facilitated by a software application that is operable to assist employers find candidates to fill job positions as recited in claim 4, wherein the account profile creation for the employers and job candidates includes receiving and recording of banking account data parameters.

6. The employee staffing method facilitated by a software application that is operable to assist employers find candidates to fill job positions as recited in claim 5, and further including a step of providing a communication platform within the software application, wherein the communication platform facilitates communication exchange between the job candidates and the employers.

7. The employee staffing method facilitated by a software application that is operable to assist employers find candidates to fill job positions as recited in claim 6, and further including a step of creating a resume for the job candidate, wherein the software application provides resume creation for the job candidate.

8. The employee staffing method facilitated by a software application that is operable to assist employers find candidates to fill job positions as recited in claim 7, and further including a step of screening a candidate, wherein the employer reviews credentials of a job candidate interested in the job opening.

9. The employee staffing method facilitated by a software application that is operable to assist employers find candidates to fill job positions as recited in claim 8, and further including a step of monitoring the job candidate, wherein the software application records and tracks activity of the job candidate within the software application.

10. The employee staffing method facilitated by a software application that is operable to assist employers find candidates to fill job positions as recited in claim 9, and further including a step of scheduling an interview with the job candidate, wherein the employer schedules an interview utilizing the software application to speak with the job candidate.
